(19) United States
(12) Patent Application Publication
(10) Pub. No.: US 2022/0065025 A1
(43) Pub. Date: Mar. 3, 2022

(54) Cover Film for Plastic Foam Laminates

(71) Applicant: Mark A. Shippen, Prattville, AL (US)

(72) Inventor: Mark A. Shippen, Prattville, AL (US)

(73) Assignee: Mark A Shippen, Prattville (US)

(21) Appl. No.: 17/001,962

(22) Filed: Aug. 25, 2020

(51) Int. Cl. E06B 3/30; B32B 5/02; B32B 5/18; B32B 7/12; B32B 7/06; B32B 27/12; B32B 27/06; B32B 27/36

(52) U.S. Cl. CPC E06B 3/307; B32B 5/028; B32B 5/18; B32B 7/12; B32B 2419/00; B32B 27/12; B32B 27/065; B32B 27/36; B32B 2307/304; B32B 7/06

(57) ABSTRACT

This application is designated for use on the adhesive surface of plastic foam laminates. Such laminates can stop heat loss from architectural glass about 90-98%. The industry standard for covering silicone adhesive calls for fluoro-silicone coated films. Due to the unsuitability of these cover films, a new cover film is proposed. The preferred cover film is described as a tulle polyester/nylon mesh film about 1-5 mils thick.

### FIELD OF INVENTION

This application supports plastic foam laminates which can insulate architectural glass saving about 90-98% of the heat transfer. Of particular note is the specification of silicone based adhesives which provide the best moisture resistance. However, when a silicone adhesive is specified, the industry standard is to use a fluoro-silicone coated clear release plastic film. Unfortunately, such films have undesirable attributes. When applied to the adhesive surface of a plastic foam laminate, ripples and creases are are trapped under the cover. Also, when the cover film is trimmed without any overage, the installer must use a trial and error procedure making a tape tab to peel the cover film from the laminate body. The installer may also mistakenly start to peel an under layer of the laminate. Due to cost considerations, only one side or the cover film contains the fluoro-silicone release coating. A user requiring the removal during an off season storage will have to cover, mark or know the release side for proper storage. A mix up can ruin an entire lot of the plastic foam laminates. Since a fluoro-silicone plastic film is considered a specialty film, the supply chain is also problematic. However, the most undesirable attribute of the fluoro-silicone film is its cost. Today, the release film can cost about 40% of the entire plastic foam laminate's material cost. There is now a better cover film for the plastic foam laminates other than the standard fluoro-silicone film now costing about 2% of the entire laminate's material cost.

### EMBODIMENTS

The new preferred cover film for the line of plastic foam laminates is a tulle, polyester/nylon, thin mesh film commonly used as a disposable veil material primarily used in weddings. This material is commercially available in most fabrics stores, even stocked in colors. The advantages are:
1) Entrained creases and ripples are prevented due to the open weave of the mesh film. This improvement in the presentation is reason enough to justify its use.
2) A very easy release is created by the non continuous surface contact of the film. The film removal can be initiated with common items such as tooth picks, thumb tacks, pins, needles, forks or the like. There is practically no liability of the user damaging an under layer of the plastic foam laminate. The mesh is about 1-5 mils thick.
3) The mesh film maintains its cover function even when examined on store shelves.
4) Both sides of the mesh film are identical so there is no mix-up during off season storage.
5) The white mesh film is easily marked with a pencil for cutting sub pieces.
6) The mesh film weighs less than than the typical 2 mil fluoro-silicone release film.
7) The mesh film is not considered a specialty film. Therefore, use in a mass market application is readily feasible and more commonly available.
8) The mesh film veil allows substantial viewing of the covered, protected image.
9) The mesh film cost is about 2% of the material cost of a typical foam laminate, not like the 40% cost of a fluoro-silicone release film.

### Experimental Notes

1) Finger pressure can vary the adhesion of the mesh film to the adhesive surface. There was no indication that heavy finger pressure could cause the mesh film to fail upon removal.
2) The mesh film never failed upon removal. It was always removable and reusable.
3) The adhesion of the mesh film to the adhesive did not increase over a period of 7 days. Increasing the dwell time of the mesh film presented no problems for removal.
4) A flat mesh film profile on the adhesive surface was achieved,
5) Reuse of the film mesh using either side of the film was realized.
7) Sharp scissors are required for effective mesh film cutting in a factory setting.

### DRAWING

FIG. 1 is a sectional view of a typical plastic foam laminate comprising the thin mesh film covering.

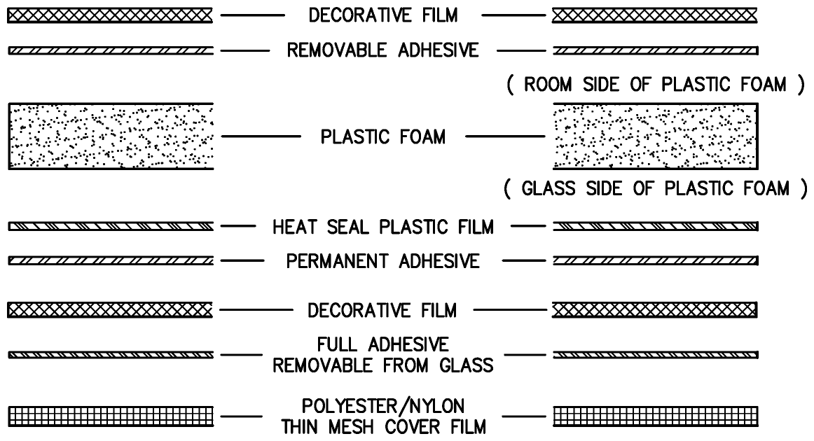

### CONCLUSION

The new use of the thin mesh film is far superior than the standard fluoro-silicone cover film covering silicone adhesive surfaces such as the typical foam laminate surface. Visual appearance, shelf display, peel performance and cost reduction make the new use of the thin polyester/nylon mesh film a highly desirable substitute.

I claim:

1) An article of architectural glass insulation including a plastic foam laminate cover film wherein said cover film comprises a tulle polyester/nylon mesh film about 1-5 mils thick and is releasable on both sides of said cover film while attaining removability and reusability of said cover film when adhered on said plastic foam laminate.
